(19) United States
(12) Patent Application Publication
(10) Pub. No.: US 2002/0017613 A1
(43) Pub. Date: Feb. 14, 2002

(54) Scintillator panel and radiation image sensor

(75) Inventors: Takuya Homme, Hamamatsu-shi (JP); Toshio Takabayashi, Hamamatsu-shi (JP)

Correspondence Address: MORGAN, LEWIS & BOCKIUS, 1800 M STREET NW, WASHINGTON, DC, 20036-5869, US

(73) Assignee: HAMAMATSU PHOTONICS K.K.

(21) Appl. No.: 09/971,943

(22) Filed: Oct. 9, 2001

Related U.S. Application Data
(63) Continuation-in-part of application No. PCT/JP00/02422, filed on Apr. 13, 2000.

(30) Foreign Application Priority Data
Apr. 16, 1999 (JP) P1999-109635

(51) Int. Cl. G01T 1/24

(52) U.S. Cl. 250/370.11; 250/483.1

(57) ABSTRACT

An Ag film as a light-reflecting film is formed on one surface of an a-C substrate of a scintillator panel. The entire surface of the Ag film is covered with an SiN film for protecting the Ag film. A scintillator having a columnar structure, which converts an incident radiation into visible light, is formed on the surface of the SiN film. The scintillator is covered with a polyparaxylylene film together with the substrate.

### RELATED APPLICATIONS

This is a Continuation-In-Part application of International Patent Application serial No. PCT/JP00/02422 filed on Apr. 13, 2000 now pending.

### BACKGROUND OF THE INVENTION

1. Field of the Invention

The present invention relates to a scintillator panel and radiation image sensor which are used for medical X-ray photography or the like.

2. Related Background Art

While X-ray sensitive films have conventionally been used in medical and industrial X-ray photography, radiation imaging systems using radiation detectors have been coming into widespread use from the viewpoint of convenience and storability of photographed results. In such a radiation imaging system, pixel data caused by two-dimensional radiation are acquired as an electric signal by a radiation detector, and this signal is processed by a processing unit, so as to be displayed on a monitor.

### SUMMARY OF THE INVENTION

Conventionally known as a typical radiation detector is one having a structure in which a scintillator panel comprising a scintillator formed on a substrate made of aluminum, glass, fused silica, or the like and an imaging device are cemented together. In this radiation detector, the radiation entering from the substrate side is converted by the scintillator into visible light, which is then detected by the imaging device (see JP7-21560A).

Meanwhile, though it is necessary for the scintillator panel to have a sufficiently high optical output in order to attain clear images in a radiation detector, the optical output has not been sufficient in the above-mentioned radiation detector.

It is an object of the present invention to provide a scintillator panel having an enhanced optical output, and a radiation image sensor using a scintillator panel having an enhanced optical output.

A scintillator panel according to the present invention comprises (1) a radiation-transmitting substrate, (2) a light reflective metal thin film disposed on the substrate, (3) a protective film covering an entire surface of the reflective metal thin film, and (4) a scintillator deposited on the protective film. And the protective film has a function to protect the reflective metal thin film against the scintillator.

According to the scintillator panel of the present invention, since the entire surface of the reflective metal thin film is covered with the protective film, any decomposition of this thin film based on water contained in the scintillator in a small amount can be prevented, and any degradation in function of the reflective metal thin film as a reflecting film can be prevented. Hence, an increased optical output of the scintillator panel can be maintained.

Another scintillator panel of the present invention comprises (1) a radiation-transmitting substrate, (2) a reflective metal thin film disposed on the substrate, (3) a protective film disposed on the reflective metal thin film, and (4) a scintillator deposited on the protective film at a position except an edge portion thereof. The reflective metal thin film transmits radiation and reflects light irradiated from the scintillator, and has a function to protect the reflective metal thin film against the scintillator.

According to this scintillator panel, since the scintillator and reflective metal thin film are separated, any decomposition of this film based on water contained in the scintillator in a small amount can be prevented, and any degradation in function of the reflective metal thin film as a reflecting film can be prevented. Hence, an increased optical output of the scintillator panel can be maintained.

The reflective film may be directly or indirectly disposed on the substrate. And the reflective film may be substantially made of a material containing a substance selected from the group consisting of Al, Ag, Cr, Cu, Ni, Ti, Mg, Rh, Pt, and Au.

The protective film may be an inorganic film like a metal oxide film or an organic film like polyimide. The inorganic film may be substantially made of a material containing a substance selected for the group consisting of LiF, MgF₂, SiO₂, TiO₂, Al₂O₃, MgO, SiN. Or the metal oxide film may be an oxidized material of the reflective metal thin film.

The protective film preferably comprises an inorganic film such as SiN and an organic film such as polyimide.

The scintillator may be covered with an organic film. According to this configuration, the water-vapor resistance of the scintillator can be improved.

Preferably, the organic film further covers at least an outer periphery of said protective film. According to this configuration, the organic film covers over the scintillator and the outer periphery of said protective film and reaches to the surface of the substrate around the protective film. Whereby the water-vapor resistance of the scintillator can be further improved as compared to a structure in which only the scintillator is covered with an organic film. And the scintillating material depositing outside the scintillator layer is prevented to contact with the reflective metal thin film.

If this organic film further covers an entire surface of the substrate then it is preferable to further improve the water-vapor resistance as compared to a structure in which of only the scintillator and at least part of the substrate surface are covered with an organic film.

A radiation image sensor according to the present invention is characterized in that an image sensing element is arranged to face the scintillator of the scintillator panel. According to the radiation image sensor of the present invention, since the scintillator panel can maintain an increased optical output, the output of the radiation image sensor can be maintained.

### BRIEF DESCRIPTION OF THE DRAWINGS

FIG. 1 is a sectional view of a scintillator panel according to the first embodiment, and

FIG. 2 is a sectional view of a radiation image sensor according to the first embodiment;

FIG. 3 is a sectional view of a scintillator panel according to the second embodiment;

FIG. 4 is a sectional view of a scintillator panel according to the third embodiment, and

FIG. 5 is a sectional view of a modification of this embodiment;

FIG. 6 is a sectional view of a scintillator panel according to the fourth embodiment;

FIG. 7 is a sectional view of a modification to the scintillator panel according to the fourth embodiment, and

FIGS. 8 and 9 are sectional views of modifications of this embodiment;

FIG. 10 is a sectional view of a scintillator panel according to the fifth embodiment;

FIG. 11 is a sectional view of a radiation image sensor according to the fifth embodiment; and

FIG. 12 is a sectional view of a scintillator panel according to the sixth embodiment, and

FIG. 13 is a sectional view of a modification of this embodiment.

### DESCRIPTION OF THE PREFERRED EMBODIMENTS

We will describe some preferred embodiments of the present invention hereinafter. To facilitate the comprehension of the explanation, the same reference numerals denote the same parts, where possible, throughout the drawings, and a repeated explanation will be omitted.

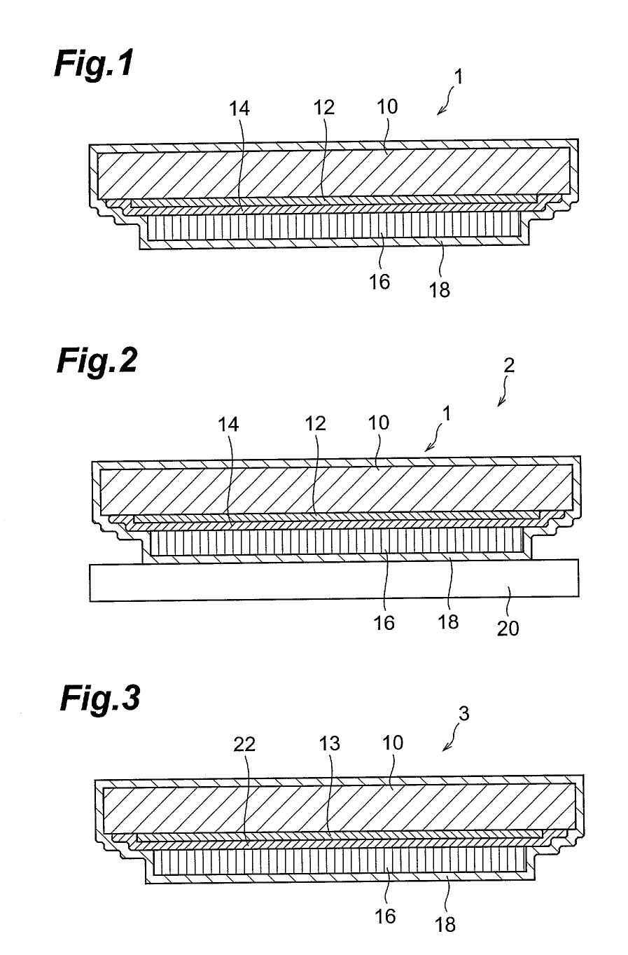

The first embodiment of the present invention will be described below with reference to FIGS. 1 and 2. FIG. 1 is a sectional view of a scintillator panel 1, and FIG. 2 is a sectional view of a radiation image sensor 2.

As shown in FIG. 1, an Ag film 12 as a light-reflecting film (reflective metal thin film) is disposed on one surface of an amorphous carbon (a-C) (glassy carbon or glass-like carbon) substrate 10 of the scintillator panel 1. The surface of the Ag film 12 is covered with an SiN film 14 for protecting the Ag film 12. A scintillator 16 with a columnar structure, which converts incident radiation into visible light, is made on the surface of the SiN film 14. Tl-doped CsI is used as the scintillator 16. This scintillator 16 is covered with a polyparaxylylene film 18 together with the substrate 10.

The radiation image sensor 2 has a structure in which an image sensing element 20 is bonded to the distal end portion side of the scintillator 16 of the scintillator panel 1, as shown in FIG. 2.

The manufacturing process of the scintillator panel 1 will be described. First, an Ag film 12 as a light-reflecting film is formed to a thickness of 150 nm on one surface of a rectangular or circular a-C substrate 10 (thickness: 1 mm) by vacuum deposition. An SiN film 14 is formed to a thickness of 200 nm on the Ag film 12 by plasma CVD to cover the entire surface of the Ag film 12.

A columnar crystal of Tl-doped CsI is grown (deposited) on the surface of the SiN film 14 by deposition, thereby forming a scintillator 16 having a thickness of 250 μm. CsI that forms the scintillator 16 has high hygroscopicity, and if the scintillator is kept exposed, it absorbs vapor in air and deliquesces. To prevent this deliquescence, a polyparaxylylene film 18 is formed by CVD. That is, the substrate 10 with the scintillator 16 formed is placed in a CVD apparatus, and a polyparaxylylene film 18 is deposited to a thickness of 10 μm. With the above process, the polyparaxylylene film 18 is formed on the entire surfaces of the scintillator 16 and substrate 10 (the entire substrate surface that is exposed without any scintillator or the like).

The radiation image sensor 2 is manufactured by bonding the light-receiving portion of the image sensing element (CCD) 20 to the distal end portion side of the scintillator 16 of the completed scintillator panel 1 (FIG. 2).

According to the radiation image sensor 2 of this embodiment, radiation incident from the substrate 10 side is converted into light by the scintillator 16 and detected by the image sensing element 20. Since the scintillator panel 1 of the radiation image sensor 2 has the Ag film 12 as a reflective metal thin film, the light incident on the light-receiving portion of the image sensing element 20 can be increased, and a clear image can be detected by the radiation image sensor 2. In addition, since the Ag film 12 is wholly covered with the SiN film 14 that functions as a protective film for the Ag film 12, the function for a reflecting film of the Ag film 12 can be prevented from being damaged by de composition due to corrosion or the like. Furthermore, when the scintillator 16 is deposited the CsI deposits not only on the region on the SiN film 14 but also deposits outside of the SiN film 14. According to the present invention, the outer periphery of the SiN film 14 is covered over the polyparaxylylene film 18, the CsI which deposits outside of the SiN film 14 cannot intrude into the SiN film 14 and cannot contact with Ag film 12. So the Ag film 12 is effectually protected against the CsI.

The second embodiment of the present invention will be described next. In the second embodiment to be described below, the same reference numerals as in the scintillator panel 1 and radiation image sensor 2 of the first embodiment denote the same components in the second embodiment.

FIG. 3 is a sectional view of a scintillator panel 3. As shown in FIG. 3, an Al film 13 serving as a reflecting film is formed on one surface of an a-C substrate 10 of the scintillator panel 3. The surface of the Al film 13 is covered with a polyimide film 22 for protecting the Al film 13. A scintillator 16 with a columnar structure, which converts incident radiation into visible light, is formed on the surface of the polyimide film 22. Tl-doped CsI is used as the scintillator 16. This scintillator 16 is covered with a polyparaxylylene film 18 together with the substrate 10.

A radiation image sensor is constructed by bonding an image sensing element to the distal end portion side of the scintillator 16 of the scintillator panel 3.

The manufacturing process of the scintillator panel 3 will be described. First, an Al film 13 as a light-reflecting film is formed to a thickness of 150 nm on one surface of a rectangular or circular a-C substrate 10 (thickness: 1 mm) by vacuum deposition. A polyimide film 22 is formed to a thickness of 1,000 nm on the Al film 13 by a spin coat process to cover the entire surface of the Al film 13.

A columnar crystal of Tl-doped CsI is grown on the surface of the polyimide film 22 by deposition, thereby forming a scintillator 16 having a thickness of 250 μm. CsI that forms the scintillator 16 has high hygroscopicity, and if the scintillator is kept exposed, it absorbs vapor in air and deliquesces. To prevent this deliquescence, the polyparaxylylene film 18 is formed by CVD. That is, the polyparaxylylene film 18 is formed on the entire surfaces of the scintillator 16 and substrate 10.

The radiation image sensor is manufactured by bonding the light-receiving portion of an image sensing element (CCD) 20 to the distal end portion side of the scintillator 16 of the completed scintillator panel 3.

According to the radiation image sensor using the scintillator panel 3 of this embodiment, radiation incident from the substrate 10 side is converted into light by the scintillator 16 and detected by the image sensing element 20. Since the scintillator panel 3 of the radiation image sensor has the Al film 13 as a reflective metal thin film, the light incident on the light-receiving portion of the image sensing element can be increased, and a clear image can be detected by the radiation image sensor. In addition, since the Al film 13 is wholly covered with the polyimide film 22 that functions as a protective film for the Al film 13, the Al film 13 as a reflecting film can be prevented from being damaged in function by a decomposition due to corrosion or the like.

The third embodiment of the present invention will be described next. In the third embodiment to be described below, the same reference numerals as in the scintillator panel 1 and radiation image 2 of the first embodiment denote the same components in the third embodiment.

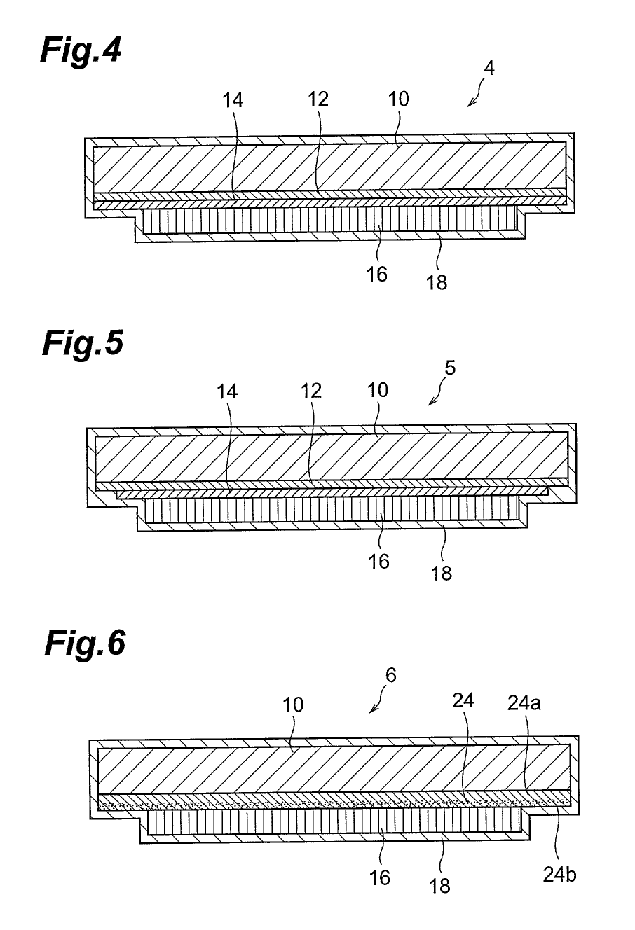

FIG. 4 is a sectional view of a scintillator panel 4. As shown in FIG. 4, an Ag film 12 as a light-reflecting film is formed on one surface of an a-C substrate 10 of the scintillator panel 4. An SiN film 14 for protecting the Ag film 12 is formed on the entire surface of the Ag film 12. A scintillator 16 with a columnar structure, which converts an incident radiation into visible light, is formed on the surface of the SiN film 14.

The scintillator 16 is formed at a position except the edge portion on the SiN film 14 so that the scintillator 16 located on the outer side is separated from the edge portion of the Ag film 12. Tl-doped CsI is used as the scintillator 16. This scintillator 16 is covered with a polyparaxylylene film 18 together with the substrate 10.

A radiation image sensor is constructed by bonding an image sensing element to the distal end portion side of the scintillator 16 of the scintillator panel 4.

According to the radiation image sensor using the scintillator panel 4 of this embodiment, radiation incident from the substrate 10 side is converted into light by the scintillator 16 and detected by an image sensing element 20. Since the scintillator panel 4 of the radiation image sensor has the Ag film 12 as a reflective metal thin film, the light incident on the light-receiving portion of the image sensing element 20 can be increased, and a clear image can be detected by the radiation image sensor. In addition, since the edge portion of the Ag film 12 is separated from the scintillator 16, the Ag film 12 as a reflecting film can be prevented from being damaged in function by a decomposition due to corrosion or the like.

In the scintillator panel 4 according to the third embodiment, the SiN film 14 is formed on the entire surface of the Ag film 12. However, as in a scintillator panel 5 shown in FIG. 5, the SiN film 14 may be formed at a position except the edge portion of the Ag film 12, and the scintillator 16 may be formed at a position except the edge portion of the SiN film 14. Even in this case, since the edge portion of the Ag film 12 is separated from the scintillator 16, the Ag film 12 as a reflecting film can be prevented from being damaged in function by a decomposition due to corrosion or the like.

The fourth embodiment of the present invention will be described next. In the fourth embodiment to the described below, the same reference numerals as in the scintillator panel 1 and the radiation image sensor 2 of the first embodiment denote the same components in the fourth embodiment.

FIG. 6 is a sectional view of a scintillator panel 6. As shown in FIG. 6, an Al film 24 made of an Al film 24a and Al₂O₃ film (oxide film) 24b is formed on one surface of an a-C substrate 10 of the scintillator panel 6. A scintillator 16 with a columnar structure, which converts an incident radiation into visible light, is formed on the Al₂O₃ film 24b on the surface of the Al film 24. Tl-doped CsI is used as the scintillator 16. This scintillator 16 is covered with a polyparaxylylene film 18 together with the substrate 10.

A radiation image sensor is constructed by bonding an image sensing element to the distal end portion side of the scintillator 16 of the scintillator panel 6.

The manufacturing process of the scintillator panel 6 will be described. First, an Al film 24 as a light-reflecting film is formed to a thickness of 150 nm on one surface of a rectangular or circular a-C substrate 10 (thickness: 1 mm) by vacuum deposition. Subsequently, Al is evaporated while supplying oxygen gas, thereby forming an Al₂O₃ film 24b having a thickness of 30 nm on the entire surface of the Al film 24a.

A columnar crystal of Tl-doped CsI is grown on the surface of the Al₂O₃ film 24b by deposition, thereby forming a scintillator 16 having a thickness of 250 μm. CsI that forms the scintillator 16 has high hygroscopicity, and if the scintillator is kept exposed, it absorbs vapor in air and deliquesces. To prevent this deliquescence, a polyparaxylylene film 18 is formed by CVD. That is, the polyparaxylylene film 18 is formed on the entire surfaces of the scintillator 16 and substrate 10.

A radiation image sensor is constructed by bonding an image sensing element to the distal end portion side of the scintillator 16 of the scintillator panel 6.

According to the radiation image sensor using the scintillator panel 6 of this embodiment, radiation incident from the substrate 10 side is converted into light by the scintillator 16 and detected by an image sensing element 20. Since the scintillator panel 6 of the radiation image sensor has the Al film 24a as a reflective metal thin film, the light incident on the light-receiving portion of the image sensing element 20 can be increased, and a clear image can be detected by the radiation image sensor.

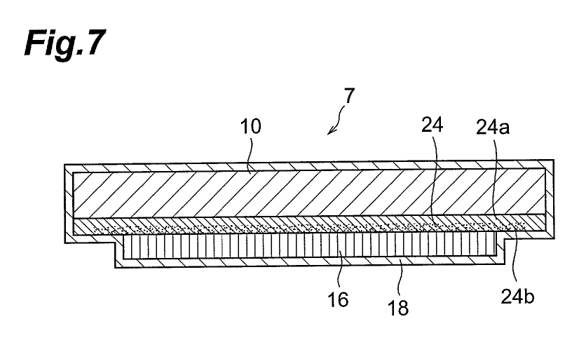

In addition, since the Al film 24a is wholly covered with the Al₂O₃ film 24b as a protective film for the Al film 24a, the Al film 24a as a reflecting film can be prevented from being damaged in function by a decomposition due to corrosion or the like. In addition, since the edge portion of the Ag film 12 is separated from the scintillator 16, the Ag film 12 as a reflecting film can be prevented from being damaged in function by a decomposition due to corrosion or the like. In the scintillator panel 6 according to the fourth embodiment, the Al₂O₃ film 24b is formed on the entire surface of the Al film 24a. However, as in a scintillator panel 7 shown in FIG. 7, the Al₂O₃ film 24b may be formed at a position except the edge portion of the Al film 24a. Even in this case, since the edge portion of the Al film 24 is separated from the scintillator 16, the Al film 24a as a reflecting film can be prevented from being damaged in function by a decomposition due to corrosion or the like.

In the above-described embodiments, an a-C substrate is used. However, since the substrate only need to pass radiation, a graphite substrate, Al substrate, Be substrate, or glass substrate may be used.

In the above-embodiments, when an Al oxide film on the substrate is used as a protective film, a polyimide film as a protective film is also preferably formed on the oxide film. In this case, the Al film can be completely protected by the oxide film and polyimide film.

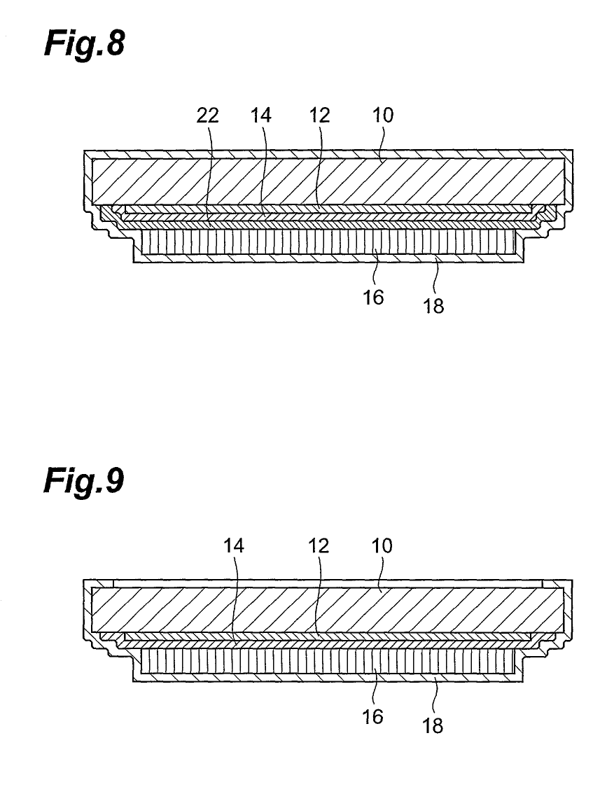

In the above-embodiments, an SiN film or polyimide film is used as a protective film. However, the present invention is not limited to this. A film made of a material containing a substance selected from the group consisting of transparent inorganic films such as LiF, MgF₂, SiO₂, Al₂O₃, TiO₂, MgO, and SiN and a transparent organic film such as polyimide may be used. Alternatively, a protective film formed from inorganic and organic films may be used, as shown in FIG. 8. That is, in a scintillator panel shown in FIG. 8, an Ag film 12 as a light-reflecting film is formed on one surface of an a-C substrate 10. The surface of the Ag film 12 is covered with the SiN film (inorganic film) 14 for protecting the Ag film 12, and the surface of the SiN film 14 is covered with a polyimide film (organic film) 22. A scintillator 16 having a columnar structure is formed on the surface of the polyimide film 22. The scintillator 16 is covered with a polyparaxylylene film 18 together with the substrate 10. When a protective film formed from inorganic and organic films is used, as in the scintillator panel shown in FIG. 8, the effect for protecting the light-reflecting film can be further improved.

In the above-described embodiments, an Ag film or Al film is used as a reflective metal thin film. However, a film made of a material containing a substance selected from the group consisting of Al, Ag, Cr, Cu, Ni, Ti, Mg, Rh, Pt, and Au may be used. In addition, two or more reflective metal thin films may be formed by forming, e.g., an Au film on a Cr film.

In the above-described embodiments, when a film made of a material containing a substance selected from the group consisting of Al, Ag, Cr, Cu, Ni, Ti, Mg, Rh, and Pt is used as a reflective metal thin film, an oxide film thereof can be used as a protective film.

In the above-described embodiments, the entire surfaces of the scintillator 16 and substrate (the surface with the scintillator formed and a surface on the opposite side, i.e., the radiation incident surface) are covered with the polyparaxylylene film 18, thereby making the scintillator completely resistant against water vapor. When the entire surface of the scintillator 16 and at least part of the surface of the substrate 10 are covered with the polyparaxylylene film 18, as shown in FIG. 9, the water-vapor resistance of the scintillator can be made higher than in a case wherein only the scintillator is covered.

The fifth embodiment of the present invention will be described next. In the fifth embodiment to be described below, the same reference numerals as in the scintillator panels 1 and 3 and the radiation image sensor 2 of the first and second embodiments denote the same components in the fifth embodiment.

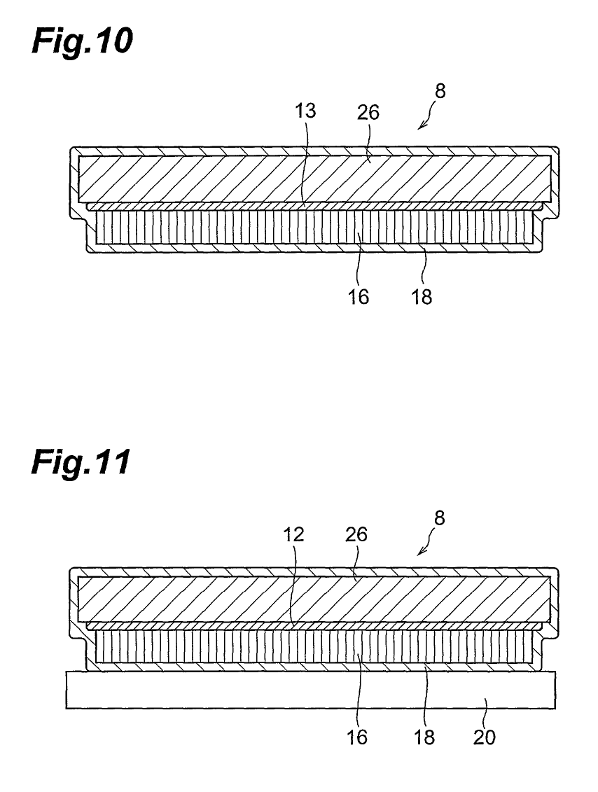

As shown in FIG. 10, a scintillator panel 8 has a glass substrate 26 having a flat shape. An Al film 13 as a reflecting film is formed to a thickness of 100 nm on one surface of the substrate by vacuum deposition. A 250-μm thick scintillator 16 with a columnar structure, which converts an incidient radiation into visible light, is formed on the surface of the Al film 13. Tl-doped CsI grown by deposition is used for the scintillator 16.

The entire surface of the scintillator 16 is covered with a 10-μm thick polyparaxylene film (transparent organic film) 18 formed by CVD, together with the substrate 26.

A radiation image sensor has a structure in which an image sensing element 20 is bonded to the distal end portion side of the scintillator 16 of the scintillator panel 8, as shown in FIG. 11.

According to the radiation image sensor of this embodiment, radiation incident from the substrate 26 side is converted into light by the scintillator 16 and detected by the image sensing element 20. Since the scintillator panel 8 of the radiation image sensor has the Al film 13 as a reflecting film, the light incident on the light-receiving portion of the image sensing element 20 can be increased, and a clear image can be detected by the radiation image sensor.

The substrate used for the scintillator panel 8 is preferably made thin to increase the radiation transmittance. When a glass substrate is used, a given rigidity can be ensured as compared to an Al substrate or a-C substrate even when the panel size is increased as in a scintillator panel used for a radiation image sensor for chest. For this reason, any deflection of the substrate can be prevented in forming a scintillator on the glass substrate. Hence, the scintillator can easily be formed on the substrate, and the quality of the formed scintillator can be maintained. As a type of glass to be used for the glass substrate of this embodiment, Pyrex glass is preferably used because of its cost and a small content of radiation absorbing component.

The sixth embodiment of the present invention will be described next. In the sixth embodiment to be described below, the same reference numerals as in the scintillator panel 5 and radiation image sensor of the fifth embodiment denote the same components in the sixth embodiment.

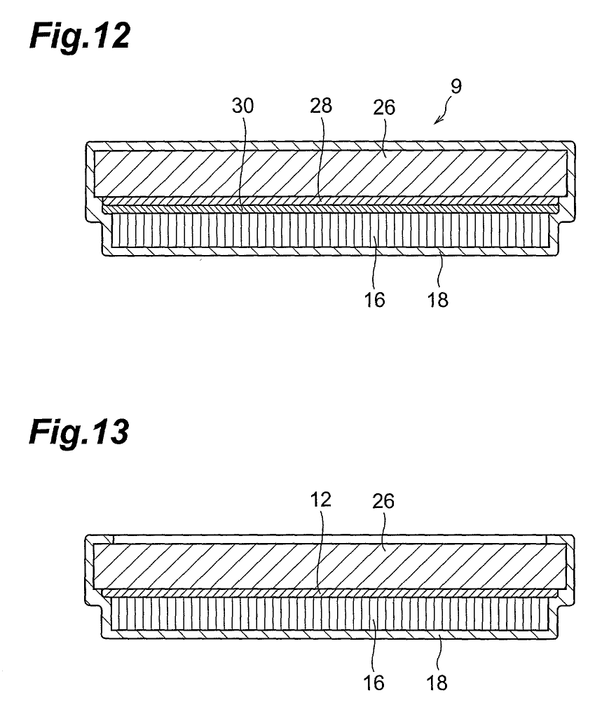

As shown in FIG. 12, a scintillator panel 9 has a glass substrate 26 having a flat shape. A Cr film 28 as a reflecting film is formed to a thickness of 100 nm on one surface of the substrate by vacuum deposition. An Au film 30 is formed on the surface of the Cr film 28, and a 250-μm thick scintillator 16 with a columnar structure is formed on the surface of the Au film 30. Tl-doped CsI grown by deposition is used as the scintillator 16.

The entire surface of the scintillator 16 is covered with a 10-μm thick polyparaxylylene film (transparent organic film) 18 formed by CVD, together with the substrate 26. A radiation image sensor has a structure in which an image sensing element 20 is bonded to the distal end portion side of the scintillator 16 of the scintillator panel 9.

Since the reflecting film of the scintillator panel according to this embodiment is formed from the Cr film 28 with good adhesion to the glass substrate and the Au film 30 with good bonding to Cr, the reflecting film can have high stability.

In the above-described embodiments, a film made of a material containing a substance selected from the group consisting of Al, Ag, Cr, Cu, Ni, Ti, Mg, Rh, Pt, and Au may be used as a reflective metal thin film.

In the above-described embodiments, CsI (Tl) is used as the scintillator 16. However, the present invention is not limited to this, and CsI (Na), NaI (Tl), LiI (Eu), KI (Tl), or the like may be used.

In the above-described embodiments, the entire surfaces of the scintillator 16 and substrate (the surface with the scintillator formed and a surface on the opposite side, i.e., the radiation incident surface) are covered with the polyparaxylylene film 18, thereby making the scintillator completely resistance against water vapor. When the scintillator 16 and at least part of the surface of the substrate are covered with the polyparaxylylene film 18, as shown in FIG. 13, the water-vapor resistance of the scintillator can be made higher than in a case wherein only the scintillator is covered.

Polyparaxylylene in the above-described embodiments includes, in addition to polyparaxylylene, polymonchloroparaxylylene, polydichloroparaxylylene, polytetrachloroparaxylylene, polyfluoroparaxylylene, polydimethlyparaxylylene, polydiethylparaxylylene, and the like.

According to the scintillator panel of the present invention, any change in properties of the reflective metal thin film based on water contained in the scintillator in a small amount can be prevented, and the function of the reflective metal thin film as a reflecting film can be prevented from degrading. Hence, an increased optical output of the scintillator panel can be maintained. When a glass substrate is used, even a scintillator panel having a large area can keep its performance high.

In addition, according to the radiation image sensor of the present invention, since the scintillator panel can maintain an increased optical output, the output of the radiation image sensor can be maintained. When a glass substrate is used, even a radiation image sensor having a large area can keep its performance high.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A scintillator panel comprising:
a radiation-transmitting substrate;
a reflective metal thin film disposed on said substrate;
a protective film covering an entire surface of said reflective metal thin film; and
a scintillator deposited on said protective film,
and wherein said protective film has a function to protect said reflective metal thin film against said scintillator.

2. A scintillator panel according to claim 1, wherein said reflective metal thin film is directly disposed on said substrate.

3. A scintillator panel according to claim 1, wherein said reflective metal thin film is substantially made of a material containing a substance selected from the group consisting of Al, Ag, Cr, Cu, Ni, Ti, Mg, Rh, Pt, and Au.

4. A scintillator panel according to claim 1, wherein said protective film is an inorganic film.

5. A scintillator panel according to claim 4, wherein said protective film is substantially made of a material containing a substance selected for the group consisting of LiF, MgF₂, SiO₂, TiO₂, Al₂O₃, MgO and SiN.

6. A scintillator panel according to claim 1, wherein said protective film is an organic film.

7. A scintillator panel according to claim 6, wherein said protective film is substantially made of polyimide.

8. A scintillator panel according to claim 4, wherein said protective film is a metal oxide film.

9. A scintillator panel according to claim 8, wherein said protective film is an oxidized material of said reflective metal thin film.

10. A scintillator panel according to claim 1, wherein said protective film includes an inorganic film and an organic film.

11. A scintillator panel according to claim 1, further comprised of an organic film covered said scintillator.

12. A scintillator panel according to claim 11, wherein said organic film further covers at least an outer periphery of said protective film.

13. A scintillator panel according to claim 12, wherein said organic film further covers an entire surface of said substrate.

14. A radiation image sensor characterized in that an image sensing element is arranged to face said scintillator of said scintillator panel of claim 1.

15. A scintillator panel characterized by comprising:
a radiation-transmitting substrate;
a reflective metal thin film disposed on said substrate;
a protective film disposed on said reflective metal thin film; and
a scintillator deposited on said protective film at a position except an edge portion thereof,
wherein said reflective metal thin film transmits radiation and reflects light irradiated from said scintillator,
and wherein said protective film has a function to protect said reflective metal thin film against said scintillator.

16. A scintillator panel according to claim 15, wherein said reflective metal thin film is directly disposed on said substrate.

17. A scintillator panel according to claim 15, wherein said reflective metal thin film is substantially made of a material containing a substance selected from the group consisting of Al, Ag, Cr, Cu, Ni, Ti, Mg, Rh, Pt, and Au.

18. A scintillator panel according to claim 15, wherein said protective film is an inorganic film.

19. A scintillator panel according to claim 18, wherein said protective film is substantially made of a material containing a substance selected for the group consisting of LiF, MgF₂, SiO₂, TiO₂, Al₂O₃, MgO and SiN.

20. A scintillator panel according to claim 14, wherein said protective film is an organic film.

21. A scintillator panel according to claim 20, wherein said protective film is substantially made of polyimide.

22. A scintillator panel according to claim 18, wherein said protective film is a metal oxide film.

23. A scintillator panel according to claim 22, wherein said protective film is an oxidized material of said reflective metal thin film.

24. A scintillator panel according to claim 15, wherein said protective film includes an inorganic film and an organic film.

25. A scintillator panel according to claim 15, further comprised of a organic film covered said scintillator.

26. A scintillator panel according to claim 25, wherein said organic film further covers at least part of a surface of said substrate.

27. A scintillator panel according to claim 26, wherein said organic film further covers an entire surface of said substrate.

28. A radiation image sensor characterized in that an image sensing element is arranged to face said scintillator of said scintillator panel of claim 15.
